(19) United States
(12) Patent Application Publication
(10) Pub. No.: US 2026/0155708 A1
(43) Pub. Date: Jun. 4, 2026

(54) Interior Permanent Magnet Motor With Active Cooling

(71) Applicant: Caterpillar Inc., Peoria, IL (US)

(72) Inventors: Jeffery Thomas Michielutti, Edina, MN (US); Jacob Dean Randall, Peoria, IL (US); Mark Allen Garety, Metamora, IL (US); Dustin Scott Friedrich, Groveland, IL (US)

(73) Assignee: Caterpillar Inc., Peoria, IL (US)

(21) Appl. No.: 18/965,201

(22) Filed: Dec. 2, 2024

(51) Int. Cl. H02K 9/19; H02K 1/276; H02K 1/28; H02K 1/32; H02K 7/00

(52) U.S. Cl. CPC H02K 9/19; H02K 1/276; H02K 1/28; H02K 1/32; H02K 7/003

(57) ABSTRACT

An interior permanent magnet motor, including a housing including a sump and a fluid transfer system configured to transfer a fluid from the sump to other portions of the housing; a rotor with a shaft having a first end, a second end, and a center section, a first end plate and a second end plate disposed on the center section of the shaft proximate the first end and the second end, a center plate disposed on the center section between the first end plate and the second end plate, a plurality of magnets disposed within magnet slots arranged circumferentially within the center plate, a plurality of passages formed within the first end plate, the center plate, and the second end plate, allowing a fluid to flow through the rotor; and a stator disposed within the housing about the rotor, configured to receive electric power and induce rotation in the rotor.

### TECHNICAL FIELD

The present disclosure generally relates to interior permanent magnet (IPM) motors, and more particularly relates to cooling systems within IPM motors.

### BACKGROUND

Electric motors are fundamental devices that convert electrical energy into mechanical energy. They are widely used across various industries, powering everything from household appliances and industrial machinery to electric vehicles and aerospace systems. The basic principle of operation for an electric motor is the interaction between magnetic fields and electric currents within the motor's components, which generates the rotational force necessary for mechanical work. Electric motors generally consist of a stator, which takes electric current and generates a magnetic field, and a rotor, which typically includes a shaft with surface-mounted magnets such that the magnetic field generated by the stator induces rotation of the rotor.

Interior Permanent Magnet (IPM) motors have become increasingly significant in various applications due to their high efficiency, power density, and robust performance characteristics. These motors feature permanent magnets embedded within the rotor, as opposed to being mounted on the surface, which provides several distinct advantages over conventional motor designs.

One of the primary benefits of IPM motors is their ability to produce both high torque and high speed performance. The embedded magnets create a stronger and more stable magnetic field, allowing the motor to operator over a wide range of speeds. This makes IPM motors particularly suitable for applications requiring variable speed and high torque, such as in electric vehicles, where both acceleration and electrical efficiency are critical.

Another advantage of IPM motors is their enhanced durability and reliability. By embedding the magnets within the rotor, they are better protected from physical damage and demagnetization, which can be a concern in surface-mounted magnet designs. Additionally, the placement of magnets inside the rotor reduces the centrifugal forces acting on them during high speed rotation, further increasing the motor's operational lifespan.

Despite these advantages, the design and optimization of IPM motors present several technical challenges. Specifically, IPM motors may operate at higher temperatures than surface-mounted magnet motors. The higher temperatures may cause demagnetization of the embedded magnets, leading to worse performance and reduced lifespan of the IPM motor.

Other rotors have been employed in prior IPM motor assemblies providing cooling passages within the rotor body to cool the motor. U.S. Pub. No. 2023/0299642 A1 discloses one of these prior rotors with channels provided within the rotor body. A hollow rotor shaft supplies cooling fluid to the channels from one end of the rotor to the other, and may fling excess fluid from the exit end of the rotor to the stator of the IPM motor.

In light of the aforementioned shortcomings, there remains a need for an IPM motor with an internal cooling system that is capable of more efficiently cooling the IPM motor, and more specifically cooling the embedded magnets of the IPM motor.

### SUMMARY OF THE DISCLOSURE

In accordance with one aspect of the disclosure, an interior permanent magnet (IPM) motor may be provided. The IPM motor may comprise a housing including a sump and a fluid transfer system configured to transfer a fluid from the sump to the rotor. The IPM motor may comprise a rotor including a shaft with a first end, a second end, and a center section. The rotor may further include a first end plate and a second end plate disposed on the center section of the shaft proximate the first end and the second end, with a rotor disposed on the center section between the first end plate and the second end plate. The rotor may include a plurality of magnets disposed within a plurality of magnet slots arranged circumferentially within the center plate. The rotor may include a plurality of passages formed within the first end plate, the center plate, and the second end plate configured to permit the fluid to flow from a plurality of passage inlets, through the plurality of passages within the rotor, and out of a plurality of passage outlets. The IPM motor may comprise a stator disposed within the housing about the rotor, and configured to receive electric power and induce rotation in the rotor.

In accordance with another aspect of the present disclosure, a rotor configured to be used in an interior permanent magnet motor may be provided. The rotor may comprise a shaft with a first end, a second end, and a center section. The rotor may comprise a first end plate disposed on the center section of the shaft proximate the first end of the shaft. The rotor may comprise a second end plate disposed on the center section of the shaft proximate the second end of the shaft. The rotor may comprise a center plate disposed on the center section of the shaft between the first end plate and the second end plate. The rotor may comprise a magnet disposed within a magnet slot of the center plate, the magnet configured to interact with a stator of the interior permanent magnet motor to generate a rotation of the rotor. The rotor may comprise a passage formed within the first end plate, the center plate, and the second end plate configured to permit a fluid to flow from a passage inlet in either the first end plate or the second end plate to a passage outlet in the other of the first end plate or the second end plate, the passage being disposed in the center plate proximate the magnet.

In accordance with yet another aspect of the disclosure, a method of operating an interior permanent magnet motor may be provided. The method may comprise providing the interior permanent magnet motor comprising a stator and a rotor disposed within a housing, the rotor having a shaft with a first end and a second end, a first end plate, a second end plate, and a center plate. The method may comprise transferring a fluid from a sump of the interior permanent magnet motor to the first end plate and the second end plate of the rotor. The method may comprise gathering the fluid in an inlet annulus in the first end plate and the second end plate, the inlet annulus connected to a plurality of passages disposed within the first end plate, the center plate, and the second end plate such that fluid pressure builds within the inlet annulus and travels through the plurality of passages. The method may comprise gathering the fluid in an outlet annulus disposed in the first end plate and the second end plate such that a dam of outlet fluid forms within the outlet annulus. The method may comprise flowing an excess of fluid from the dam of outlet fluid onto the stator and back into the sump.

These and other aspects and features of the present disclosure will be more readily understood when read in conjunction with the accompanying drawings.

### BRIEF DESCRIPTION OF THE DRAWINGS

FIG. 1 is a cross-section view of an IPM motor constructed in accordance with an embodiment of the present disclosure.

FIG. 2 is a perspective view of a rotor of an IPM motor constructed in accordance with an embodiment of the present disclosure.

FIG. 3 is a cross-section view of a rotor of an IPM motor constructed in accordance with an embodiment of the present disclosure.

FIG. 4 is a perspective view of an end plate of a rotor of an IPM motor constructed in accordance with an embodiment of the present disclosure.

FIG. 5 is a font view of a center plate of a rotor of an IPM motor constructed in accordance with an embodiment of the present disclosure.

FIG. 6 is an enhanced view of the center plate of FIG. 5 constructed in accordance with an embodiment of the present disclosure.

FIG. 7 is an enhanced view of an alternate center plate of a rotor of an IPM motor constructed in accordance with an embodiment of the present disclosure.

FIG. 8 is a cross-section view of a stator and rotor of an IPM motor indicating a flow path of cooling fluid through the rotor constructed in accordance with an embodiment of the present disclosure.

FIG. 9 is a perspective view of a passage for a fluid within the rotor of an IPM motor constructed in accordance with an embodiment of the present disclosure.

FIG. 10 is a perspective view of a plurality of passages arranged about a rotor of an IPM motor constructed in accordance with an embodiment of the present disclosure.

FIG. 11 is a perspective view of a plurality of passages arranged about a rotor of an IPM motor constructed in accordance with an embodiment of the present disclosure.

FIG. 12 is a perspective view of a plurality of passages arranged about a rotor of an IPM motor constructed in accordance with an embodiment of the present disclosure.

FIG. 13 is a perspective view of a plurality of passages arranged about a rotor of an IPM motor constructed in accordance with an embodiment of the present disclosure.

FIG. 14 is a flowchart depicting an exemplary flow of fluid through the plurality of passages of FIGS. 10-14 constructed in accordance with an embodiment of the present disclosure.

FIG. 15 is a cross-section view of a stator and rotor of an IPM motor indicating a first alternate embodiment of flow path of cooling fluid through the rotor constructed in accordance with the present disclosure.

FIG. 16 is a cross-section view of a stator and rotor of an IPM motor indicating a second alternate embodiment of flow path of cooling fluid through the rotor constructed in accordance with the present disclosure.

FIG. 17 is a cross-section view of a stator and rotor of an IPM motor indicating a first alternate embodiment of flow path of cooling fluid through the rotor constructed in accordance with the present disclosure.

FIG. 18 is flowchart depicting a sample sequence of steps for operating an interior permanent magnet motor, which may be practiced in accordance with the interior permanent magnet motor and the rotor of the present disclosure.

The figures depict one embodiment of the presented invention for purpose of illustration only. One skilled in the art will readily recognize form the following discussion that alternative embodiments of the structures and method illustrated herein may be employed without departing form the principles described herein.

### DETAILED DESCRIPTION

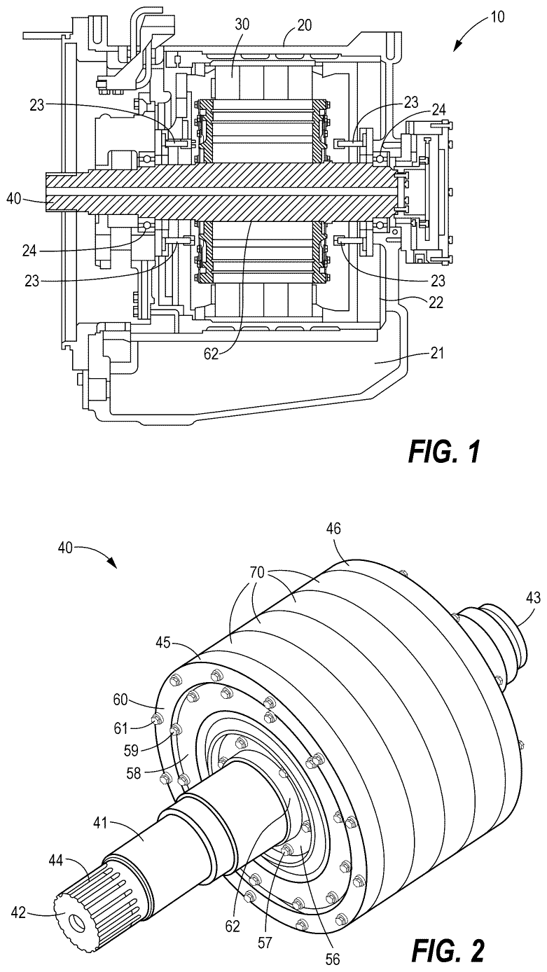

Referring now to the drawings, and with specific reference to FIG. 1, an interior permanent magnet (IPM) motor is depicted and generally referred to using reference numeral 10. The IPM motor 10 is exemplary embodied as an electric IPM motor 10. While the IPM motor 10 is depicted as such, it should be noted that a type of IPM motor used is merely exemplary and illustrative in nature. It will be acknowledged that the teachings of the present disclosure can be similarly applied to IPM motors used in various fields, including but not limited to electric vehicles, industrial machines, household appliances, and other types of machines utilizing IPM motors as known to persons skilled in the art.

IPM motors may be used to convert electrical energy into mechanical energy. The IPM motor 10 may comprise a rotor 40 including a shaft 41 with a first end 42, a second end 43, and a center section 62. FIG. 2 depicts an exemplary embodiment of the rotor 40 in a perspective view. The rotor 40 may include a first end plate 45 and a second end plate 46 disposed on the center section 62 of the shaft 41. The rotor 40 may also include a center plate disposed on the center section 62 between the first end plate 45 and the second end plate 46. As depicted in the exemplary embodiment of FIG. 2, the center plate may comprise a plurality of center plates 70, thereby forming a plurality of layers. As depicted in FIGS. 1-2, the plurality of center plates 70 may include four center plates, however, any number of the plurality of center plates 70 may be utilized as needed. In some embodiments, the plurality of center plates 70 may comprise a plurality of metal sheets.

The rotor 40 may be configured to rotate within the IPM motor 10 on the order of 6000-7000 revolutions per minute, and accordingly, the rotor 40 may be required to be balanced. In other embodiments, the rotor 40 may be configured to rotate at any other speeds as required, including much higher speeds. As such, each of the first end plate 45, the second end plate 46, and the plurality of center plates 70 may be cylindrical, having a circular cross-section.

The rotor 40 may have embedded permanent magnets in order to convert magnetic field into a rotational mechanical movement. As such, the rotor 40 may comprise a plurality of magnets 80 disposed within a plurality of magnet slots (76, 77) arranged circumferentially within the plurality of center plates 70. Each of the plurality of magnet slots (76, 77) may include an individual one of the plurality of magnets 80, or each of the plurality of magnets 80 may span the width of the plurality of center plates 70 such that the plurality of magnet slots (76, 77) are aligned with each other, and each of the plurality of center plates 70 are not rotatable relative to each other.

The rotor 40 of the IPM motor 10 generates heat as a byproduct of the induced magnetic field, and the mechanical rotational energy. Excessive heat to the plurality of magnets 80 may cause demagnetization of one or more of the plurality of magnets 80, and may lead to decreased performance and shorter lifespan of the IPM motor. In order to reduce temperature within the rotor 40, the rotor 40 may comprise a plurality of passages 100 formed within the first end plate 45, the plurality of center plates 70, and the second end plate 46. The plurality of passages 100 may be configured to permit a fluid to flow from a plurality of passage inlets 50, through the plurality of passages 100 within the rotor 40, and out of a plurality of passage outlets 51.

The IPM motor 10 may have a housing 20 for covering the internal components of the IPM motor 10. The IPM motor 10 may be required to cooled and lubricated, and as such, the housing 20 may include a sump 21 and a fluid transfer system 22 configured to transfer the fluid from the sump 21 to the rotor 40. The fluid may be a lubricating oil, a cooling oil, a cooling fluid, or any other fluid as known.

FIG. 1 depicts an exemplary embodiment of the IPM motor 10 in a cross-section view. A stator 30 may be disposed within the housing 20 about the rotor 40, and may be configured to receive electrical power and generate a magnetic field, thereby inducing rotation in the rotor 40. The rotor 40 may be disposed in the housing 20 and supported by a bearing 24 to facilitate rotation. As depicted in FIG. 1, the rotor 40 is supported by two bearings, one at each end of the rotor 40. The fluid transfer system 22 may transfer the fluid to a fluid jet 23. The fluid jet 23 may be a precision oil jet, or any other jet as known and required. As depicted in FIG. 1, a plurality of the fluid jet 23 are depicted as oriented evenly circumferentially about the rotor 40. Ideally, between two to twelve of the fluid jet 23 are evenly oriented about the rotor 40, with preferably six of the fluid jet 23 on each side of the rotor 40, thereby spraying fluid toward the first end plate 45 and the second end plate 46 of the rotor 40. However, any number of the fluid jet 23 may be utilized as required by a number of factors, for example, required flow rate within the rotor 40, distance from the first end plate 45 and the second end plate 46 to the stator 30, and required flow rate per each of the fluid jet 23.

FIG. 2 depicts an exemplary embodiment of the rotor 40. As shown, the shaft 41 of the rotor 40 may comprise a plurality of splines 44 at the first end 42 for connecting the shaft 41 rotor 40 to an output. In an exemplary embodiment, the output may be a gearing of another piece of machinery, however, the output may be any mechanical system as known, adapted to be coupled to the shaft 41.

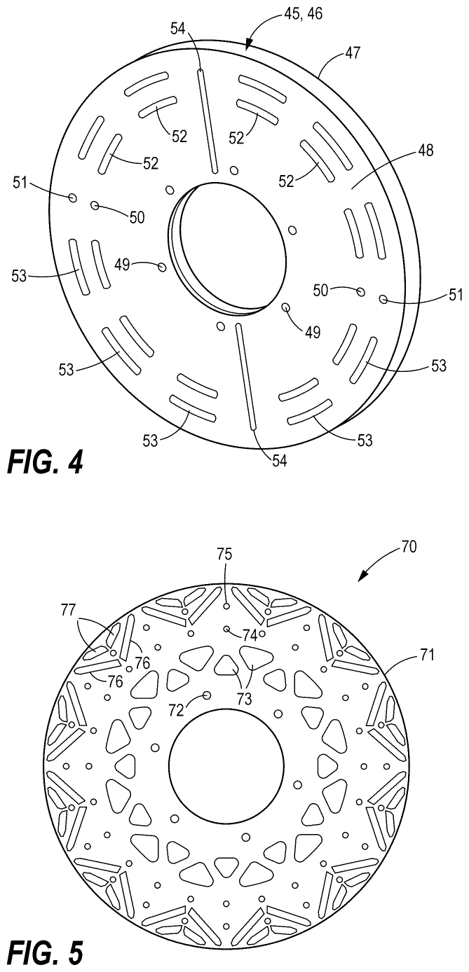

The first end plate 45 and the second end plate 46 may be substantially similar to one another. The first end plate 45 and the second end plate 46 may each have an outer plate surface 47 and an inner plate surface 48. FIG. 4 depicts an exemplary embodiment of the inner plate surface 48. The inner plate surface 48 may comprise portions of the plurality of passages 100 machined into to the inner plate surface 48, or formed through any other manufacturing process as known. As depicted in FIG. 4, the inner plate surface 48 includes a fastener hole 49, a passage inlet 50, a passage outlet 51, an inner passage connector 52, an outer passage connector 53, and a bridge connector 54 connected to a snorkel 55. The snorkel 55 may be an orifice in the in the first end plate 45 or the second end plate 46 proximate a central portion of the first end plate 45 or the second end plate 46. The snorkel 55 may connect to the bridge connector 54 and thereby connect the passage as a whole to an atmospheric pressure, permitting the plurality of passages 100 to bleed pressure dependence. The embodiment of FIG. 4 includes multiples of each of the fastener hole 49, the passage inlet 50, the passage outlet 51, the inner passage connector 52, the outer passage connector 53, the bridge connector 54, and the snorkel 55 such that several of the plurality of passages 100 may be accommodated within the rotor 40.

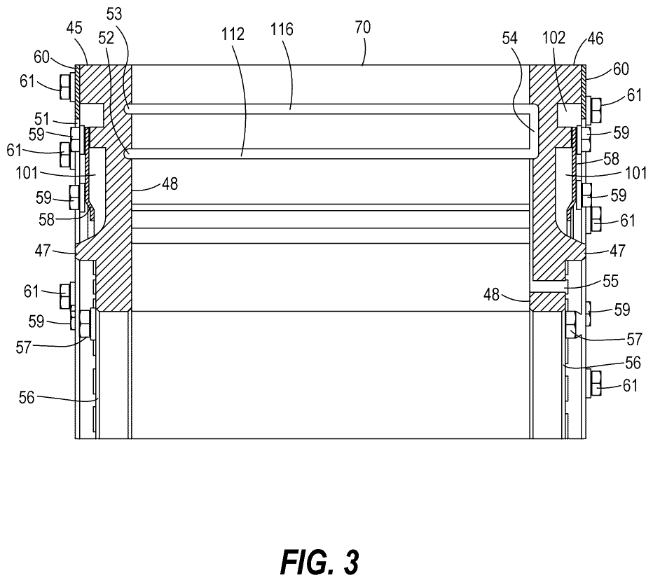

FIG. 3 depicts a cross-section of a portion of the rotor 40. The first end plate 45, the plurality of center plates 70, and the second end plate 46 may fastened together in utilizing seal plate fasteners 57 extending through each of the fastener hole 49 of the end plates and fastener holes 72 of the plurality of center plates 70. A shaft seal plate 56 may be disposed on the outer plate surface 47 of the first end plate 45 and the second end plate 46 such that the fastened plates are sealed to the shaft 41.

The outer plate surface 47 may include features allowing the rotor 40 to receive fluid delivered by the fluid jet 23, and build pressure in the fluid such that the fluid flows through the plurality of passages 100. The outer plate surface 47 may include an inlet annulus 101 disposed on the outer plate surface 47 that is connected to the passage inlet 50, the inlet annulus 101 being configured to receive a spray of the fluid from the fluid jet 23 and gather the fluid such that a fluid pressure builds within the inlet annulus 101 and travels through the plurality of passages 100. The inlet annulus 101 may include curved features on the outer plate surface that facilitate the fluid to be directed into the inlet annulus 101. Centrifugal force from rotation of the rotor 40 forces the fluid into a radially outward portion of the inlet annulus 101, wherein pressure builds until natural pumping action derived from the rotation delivers the fluid from the inlet annulus 101 and into the plurality of passages 100. An inlet annulus plate 58 may be provided on the outer plate surface 47 to define an outer wall of the inlet annulus 101, however, the inlet annulus 101 may be formed entirely within the outer plate surface 47. Inclusion of the inlet annulus plate 58 may facilitate simpler manufacturing of the outer plate surface 47 in the first end plate 45 and the second end plate 46. The inlet annulus plate 58 may be attached to the outer plate surface utilizing inlet plate fasteners 59, however, any other fastening techniques for attaching the inlet annulus plate 58 to the outer plate surface 47 may be utilized.

The outer plate surface 47 may also include an outlet annulus 102 disposed on the outer plate surface 47 that is connected to the passage outlet 51, the outlet annulus 102 being configured to gather the fluid from the passage outlet 51 and build a dam of outlet fluid. Centrifugal force from rotation of the rotor 40 similarly forces the fluid in the outlet annulus 102 to form the dam of outlet fluid until an excess of fluid has built up. The excess of fluid is forced out of the outlet annulus 102, and due to centrifugal force, is slung from the rotor 40 outward to the stator 30, thereby providing cooling to the stator 30. Once flung from the rotor 40 the fluid may drip from the stator 30 and back down into the sump 21 within the housing 20.

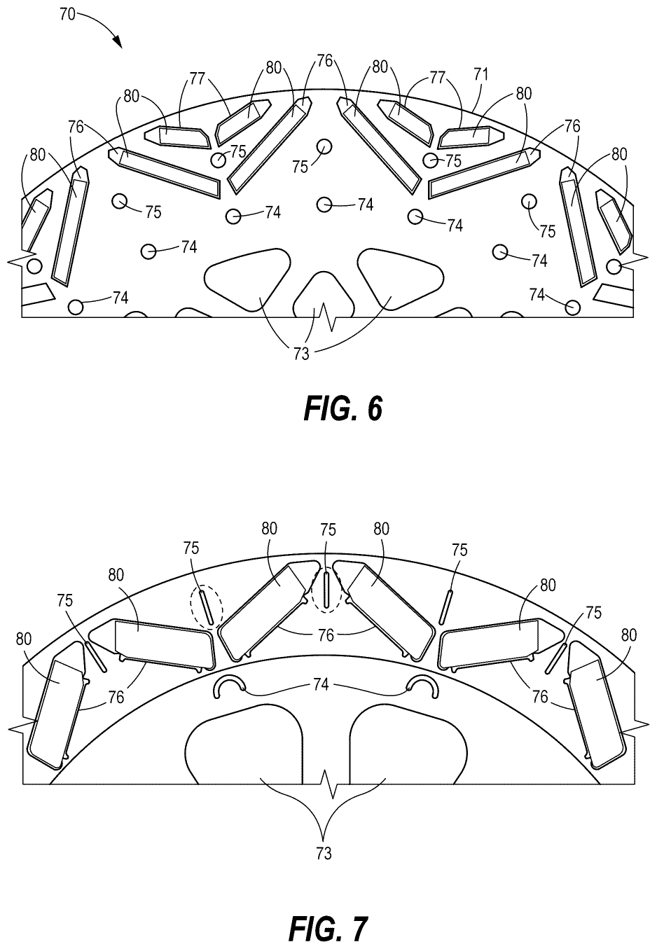

FIGS. 5-7 depict a front view and enlarged views of one of the plurality of center plates 70. Each of the plurality of center plates 70 is formed by a plate body 71 that is generally cylindrical, in other words, circular in cross-section. The plate body 71 may include fastener holes 72 for mounting adjacent ones of the plurality of center plates 70 to the first end plate 45 and the second end plate 46. The plate body 71 may include cutouts 73 in order to reduce the mass and balance the rotation of the plate body 71, thereby facilitating smoother rotation of the rotor 40. The plurality of passages 100 may be defined by the plate body, with each of the plurality of passages 100 including a plurality of inner passages 74 and a plurality of outer passages 75 proximate to magnet slots in the plate body 71 for housing the plurality of magnets 80. As depicted in the embodiment of FIGS. 5-6, the plurality of magnets 80 may include two different sets of magnets having different sizes, each having a corresponding magnet slot including a lower magnet slot 76 and an upper magnet slot 77. The embodiment of FIG. 7 includes only one set of magnets and only the lower magnet slot 76. Any number of the plurality of magnets 80 in any number of sizes may be utilized within the plate body 71. The plurality of magnets 80 may be disposed evenly about an outer circumferential portion of the plate body 71.

The plurality of inner passages 74 and the plurality of outer passages 75 may be located in the plate body 71 proximate the location of the plurality of magnets 80. As such, the fluid delivered through the plurality of inner passages 74 and the plurality of outer passages 75 may effectively cool the plurality of magnets 80. The plurality of inner passages 74 and the plurality of outer passages 75 may be substantially similar, having the same cross-sectional design. However, the plurality of inner passages 74 may have a substantially different cross-sectional design as the plurality of outer passages 75. As depicted in FIGS. 5-6, the cross-sectional designs are the same, having a circular cross section. As depicted in FIG. 7, the cross-sectional designs are different, the plurality of inner passages 74 having a horseshoe cross section, and the plurality of outer passages 75 having a slot cross section. The cross-sectional design may take any form as required, including horseshoes, circles, slots, curved slots, and stars, among others. The size of each cross-sectional design may also be modified in order to achieve specific cooling targets.

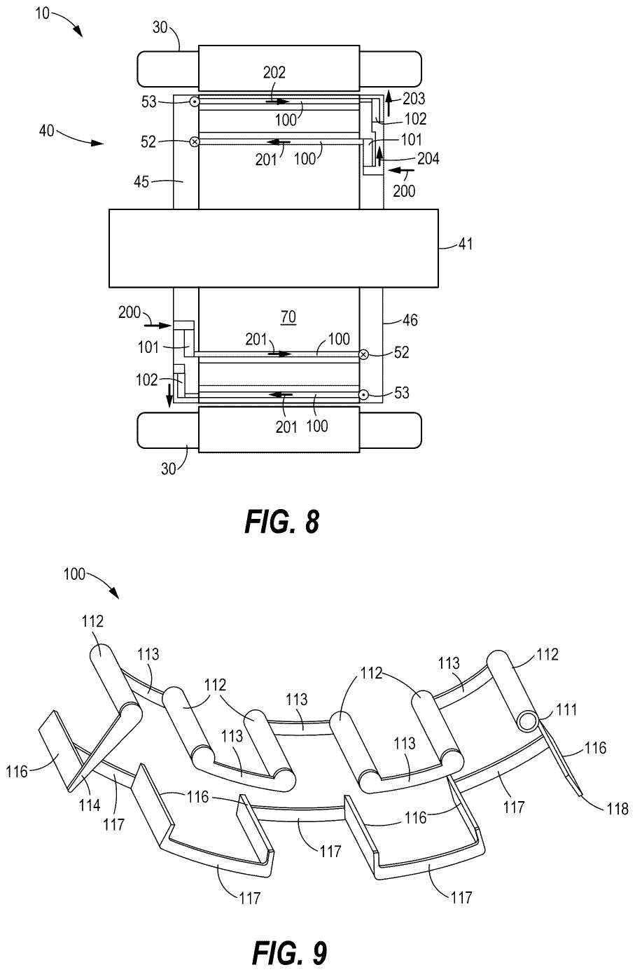

FIG. 8 illustrates a flow path of the fluid within the rotor 40 in an exemplary embodiment. The fluid is directed toward the rotor 40 by the fluid jet 23 toward the inlet annulus 101 (200). The fluid builds within the inlet annulus 101 until sufficient pressure develops the direct the fluid through the plurality of passages 100, the inner passage connector 52 and the outer passage connector 53, and into the outlet annulus 102 (201). A dam of the excess fluid builds within the outlet annulus 102 and exits the rotor 40, being flung from the rotor 40 onto the stator 30 (203). Additionally, excess fluid may build within the inlet annulus 101, spill over, and be directed directly toward the outlet annulus 102 in order to build the dam of excess fluid quicker (204).

Several of the plurality of passages 100 may be arranged about the rotor 40. FIGS. 9-14 illustrate the plurality of passages having tubular structures in order for better visualization. In the exemplary embodiment of the rotor 40, the plurality of passages 100 are formed by recesses and holes in the first end plate 45, the second end plate 46, and the plurality of center plates 70. As illustrated, the plurality of passages 100 may extend back and forth within the rotor several times, thereby forming a snake pattern.

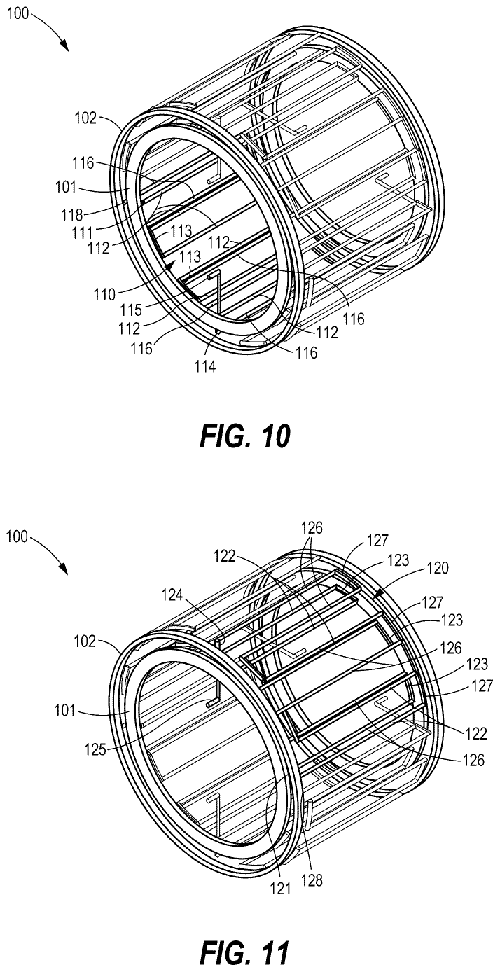

FIGS. 9 and 10 illustrate a first passage 110 of the plurality of passages 100 in an exemplary form. The first passage 110 may include a first inlet 111, a plurality of first inner passages 112, and a plurality of first inner passage connectors 113 connecting the plurality of first inner passages 112 in series. The first passage 110 may include a plurality of first outer passages 116, a first bridge connector 114 connecting the plurality of first inner passages 112 to the plurality of first outer passages 116, a plurality of first outer passage connectors 117 connecting the plurality of first outer passages 116 in series, and a first outlet 118. The fluid may travel from the first inlet 111 to the first outlet 118 in a continuous uninterrupted passage through the first passage 110.

FIGS. 10-13 depict the rotor 40 having four of the plurality of passages 100 arranged evenly about the rotor 40 and connected to an inlet annulus 101 and an outlet annulus 102 in both the first end plate 45 and the second end plate 46. The first passage 110 and the second passage 120 are oriented across from each other such that the third passage 130 and the fourth passage 140 are adjacent to the first passage 110 and the second passage 120. The first passage 110 and the second passage 120 are arranged to flow in opposite directions as the third passage 130 and the fourth passage 140. As such, the first passage 110 and the second passage 120 draw the fluid from the inlet annulus 101 disposed in the first end plate 45 and return excess fluid to the outlet annulus 102 in the first end plate 45. The third passage 130 and the fourth passage 140 draw the fluid form the inlet annulus 101 in the second end plate 46, and return excess fluid to the outlet annulus 102 in the second end plate 46.

FIG. 10 depicts the first passage 110. The first inlet 111 draws the fluid from the inlet annulus 101 disposed in the first end plate 45, and flows the fluid through the first passage 110. Centrifugal forces from the rotation of the rotor 40, as well as pressure built up within the inlet annulus 101 force the fluid to travel through the plurality of first inner passages 112 and the plurality of first inner passage connectors 113. Centrifugal forces and atmospheric pressure derived from the first snorkel 115 force the fluid to travel through the first bridge connector 114 to the plurality of first outer passages 116, and a plurality of first outer passage connectors 117. The fluid exits the first passage 110 at the first outlet 118 and is deposited into the outlet annulus 102 in the first end plate 45.

FIG. 11 depicts the second passage 120. A second inlet 121 draws the fluid from the inlet annulus 101 disposed in the first end plate 45, and flows the fluid through the second passage 120. Centrifugal forces from the rotation of the rotor 40, as well as pressure built up within the inlet annulus 101 force the fluid to travel through a plurality of second inner passages 122 and a plurality of second inner passage connectors 123. Centrifugal forces and atmospheric pressure derived from a second snorkel 125 force the fluid to travel through a second bridge connector 124 to a plurality of second outer passages 126, and a plurality of second outer passage connectors 127. The fluid exits the second passage 120 at a second outlet 128 and is deposited into the outlet annulus 102 in the first end plate 45.

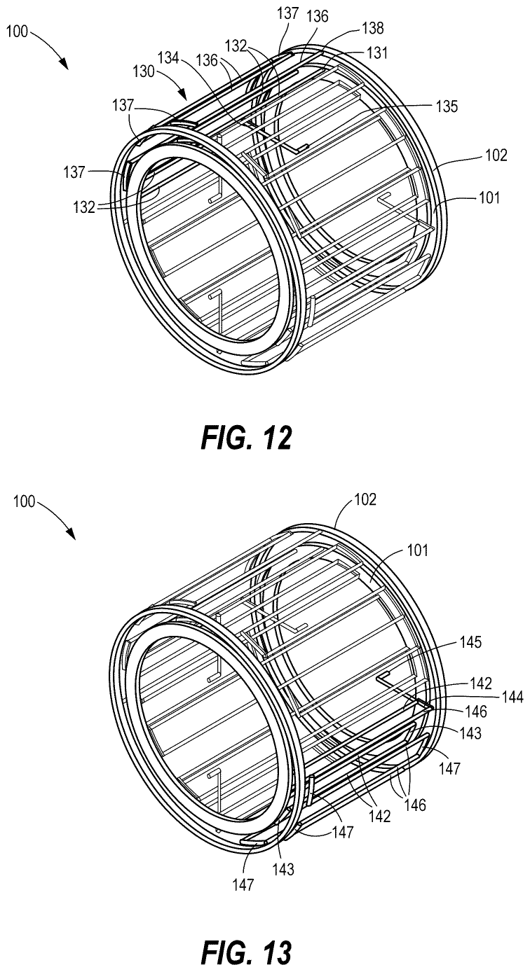

FIG. 12 depicts the third passage 130. A third inlet 131 draws the fluid from the inlet annulus 101 disposed in the second end plate 46, and flows the fluid through the third passage 130. Centrifugal forces from the rotation of the rotor 40, as well as pressure built up within the inlet annulus 101 force the fluid to travel through a plurality of third inner passages 132 and a plurality of third inner passage connectors 133. Centrifugal forces and atmospheric pressure derived from a third snorkel 135 force the fluid to travel through a third bridge connector 134 to a plurality of third outer passages 136, and a plurality of third outer passage connectors 137. The fluid exits the third passage 130 at a third outlet 138 and is deposited into the outlet annulus 102 in the second end plate 46.

FIG. 13 depicts the fourth passage 140. A fourth inlet 141 draws the fluid from the inlet annulus 101 disposed in the second end plate 46, and flows the fluid through the fourth passage 140. Centrifugal forces from the rotation of the rotor 40, as well as pressure built up within the inlet annulus 101 force the fluid to travel through a plurality of fourth inner passages 142 and a plurality of fourth inner passage connectors 143. Centrifugal forces and atmospheric pressure derived from a fourth snorkel 145 force the fluid to travel through a fourth bridge connector 144 to a plurality of fourth outer passages 146 and a plurality of fourth outer passage connectors 147. The fluid exits the fourth passage 140 at a fourth outlet 148 and is deposited into the outlet annulus 102 in the second end plate 46.

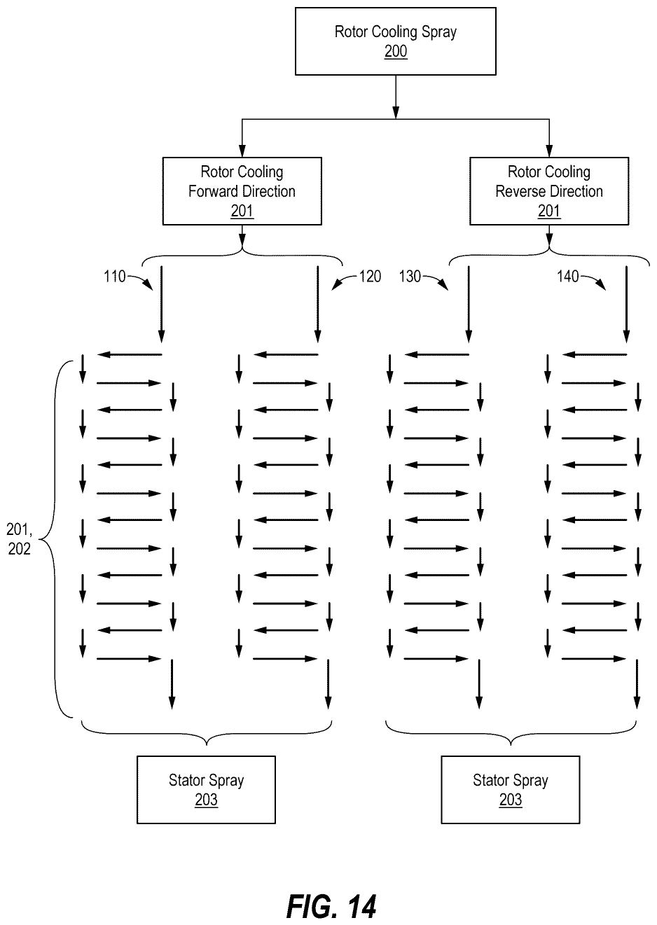

FIG. 14 depicts a flowchart of the flow of the fluid through the plurality of passages 100. In this depiction, fluid flow in the first passage 110 and the second passage 120 may be understood as a cooling flow in a forward direction. Fluid flow in the third passage 130 and the fourth passage 140 may be understood as a cooling flow in a reverse direction.

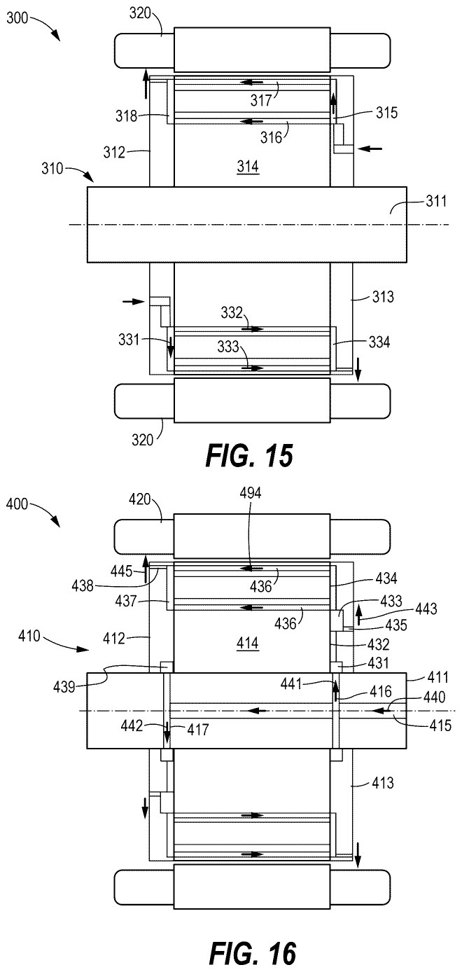

A first alternate embodiment of an IPM motor 300 is depicted in FIG. 15. The IPM motor 300 is similar to the IPM motor 10, and may include a rotor 310 with a shaft 311, a first end plate 312, a second end plate 313, a center plate 314, and a stator 320. As with the IPM motor 10, the center plate 314 of the IPM motor 300 may comprise a plurality of center plates. The IPM motor 300 is configured to route cooling fluid through the rotor 310 is a substantially different way than the IPM motor 10. In the rotor 310, a plurality of passages are formed in the first end plate 312, the second end plate 313, and the center plate 314, and the fluid is distributed in parallel paths in each of the plurality of passages, rather than a single uninterrupted path as with the rotor 40. Fluid is delivered to the first end plate 312 and the second end plate 313 in a similar manner as with the first end plate, utilizing the fluid jet 23 arrangement of the IPM motor 10 in a similar configuration in the IPM motor 300. In a forward cooling path, the fluid is collected in a forward inlet annulus 315 in the second end plate 313 until a pressure builds and the fluid may flow through a forward inner passage 316 and a forward outer passage 317 disposed in the center plate 314. The fluid flows to a forward outlet annulus 318 disposed in the first end plate 312. The fluid then flows from the forward outlet annulus 318 out of the first end plate 312, and is flung onto the stator 320. In a reverse cooling path, the fluid is collected in a reverse inlet annulus 331 in the first end plate 312 until a pressure builds and the fluid may flow through a reverse inner passage 332 and a reverse outer passage 333 disposed in the center plate 314. The fluid flows to a reverse outlet annulus 334 disposed in the second end plate 313. The fluid then flows from the reverse outlet annulus 334 out of the second end plate 313, and is flung onto the stator 320.

A second alternate embodiment of an IPM motor 400 is depicted in FIG. 16. The IPM motor 400 is similar to the IPM motor 300, and may include a rotor 410 with a shaft 411, a first end plate 412, a second end plate 413, a center plate 414, and a stator 420. As with the IPM motor 300, the center plate 414 of the IPM motor 400 may comprise a plurality of center plates. The IPM motor 400 is configured to route cooling fluid through the rotor 410 in substantially the same way as the IPM motor 300. However, the IPM motor 400 presents an alternate delivery of the fluid to the rotor 410. The fluid is delivered through a bore 415 disposed in the shaft 411 proximate a central axis of rotation of the shaft 411, and extends from a second end of the shaft 411 to a bore end within the shaft 411. A plurality of channels are connected to the bore 415 and extend through a diameter of the shaft 411. In the depiction of FIG. 16, a forward channel 416 and a reverse channel 417 may comprise the plurality of channels, and may connect the bore 415 to a forward primary annulus 431 in the second end plate 413 and a reverse primary annulus 439 in the first end plate 412. The forward primary annulus 431 may be connected to a primary fluid path 432 and a secondary annulus 433. The secondary annulus 433 may be connected to an inlet annulus 434 and a vent 435. The inlet annulus 434 is connected to fluid passages 436, an outlet annulus 437, and fluid outlet 438.

The IPM motor 400 provides a cooling system having constant rotor inlet flow. In certain IPM motors, rotor losses due to heat are greatest at high rotational speeds of the rotor 410, with stator losses due to heat being greatest at low rotational speeds of the rotor 410. The IPM motor 400 may allow for the fluid to be delivered to the stator 420 or the rotor 410 depending on where it is needed. For example, the fluid may be delivered to the rotor 410 through the bore 415 in the shaft 411 (440). The fluid may travel through the bore 415 and may be delivered to the forward primary annulus 431 and the reverse primary annulus 439 through the forward channel 416 (441) and the reverse channel 417 (442), respectively. The fluid may then be flowed into the primary fluid path 432 and the secondary annulus 433. At low rotational speed of the rotor 410, the fluid may build within the secondary annulus 433 and exit the vent 435 (443), thereby delivering the fluid to the stator 420. At high rotational speed of the rotor 410, the fluid may build within the secondary annulus 433 and exit to the inlet annulus 434. The fluid may then travel through the fluid passages 436 (444) into the outlet annulus 437 and out of the fluid outlet 438, thereby cooling the rotor 410. The fluid may then be delivered from the fluid outlet 438 to the stator 420, providing additional cooling of the stator 420 (445).

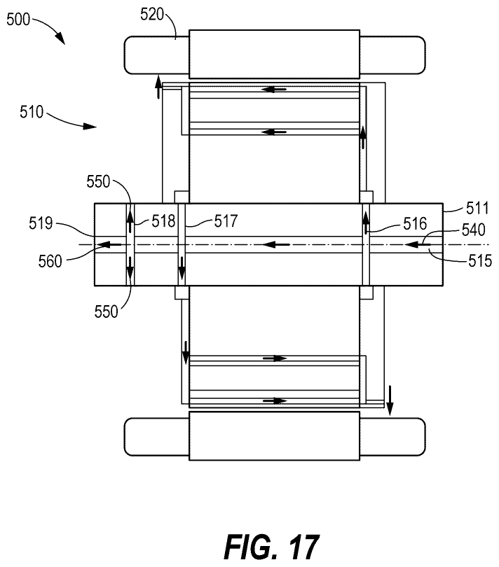

A third alternate embodiment of an IPM motor 500 is depicted in FIG. 17. The IPM motor 500 is substantially similar to the IPM motor 400, and may include a rotor 510 with a shaft 511, and a stator 520. The shaft 511 of the IPM motor 500 presents the only substantial difference to the IPM motor 400. In the shaft 511, the bore 515 extends through the entirety of the shaft 511, from a second end to a first end 519. The IPM motor 500 is configured to be connected to an output at the first end that requires a fluid to lubricate and/or cool the output. As with the shaft 41 of the IPM motor 10, the IPM motor 500 may include a plurality of splines at the first end 519 to mesh with a gearing of the output. The shaft 511 may comprise a lubricating channel 518 proximate the first end 519. The lubricating channel 518 and the bore 515 may then be configured such that the first end 519 of the shaft 511 may be connected to the output. Fluid flow through the bore 515 (540) may deliver the fluid to the output at both the first end 519 (560) and through the lubricating channel 518 located proximate the plurality of splines (550).

### Industrial Applicability

In operation, the teachings of the present disclosure can find applicability in many industries including but not limited to electric motors automotive, industrial equipment, and household appliances. While depicted and described in conjunction with an IPM motor used in an industrial setting, such teachings can also find applicability with other machines such as electric vehicles, industrial machines, household appliances, and other types of machines known to persons skilled in the art.

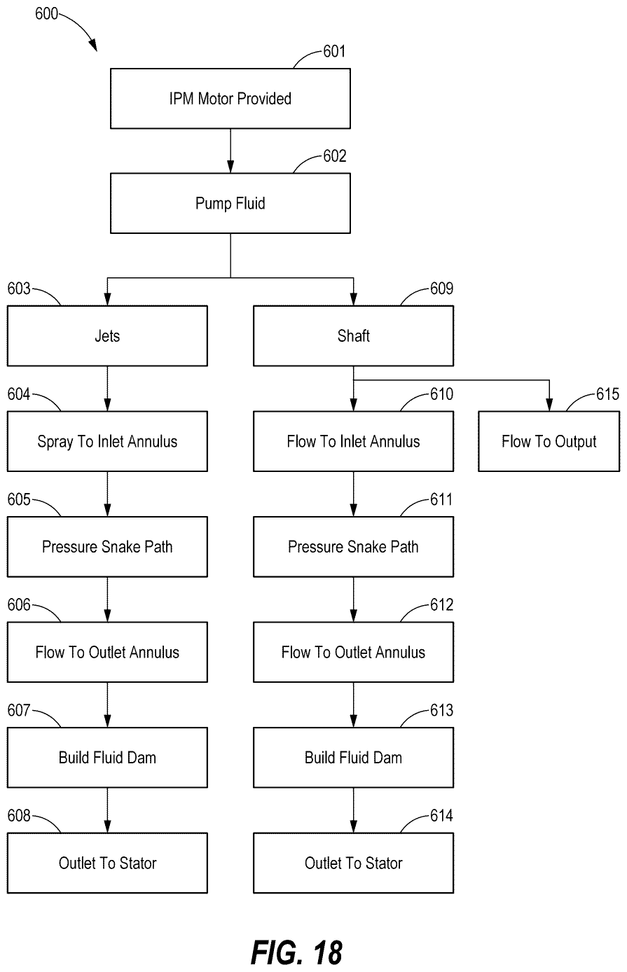

FIG. 18 illustrates a visual representation of a method 600 of operating the IPM motor 10. In a first step 601, the IPM motor 10 is provided, including the stator 30 and the rotor 40 disposed within the housing 20, the rotor 40 having the shaft 41 with the first end 42, the second end 43, the first end plate 45, the second end plate 46, and a center plate, which may be formed by a plurality of center plates 70.

In a second step 602, the IPM motor 10 may transfer the fluid from the sump 21 to the first end plate 45 and the second end plate 46 of the rotor 40. The IPM motor 10 may accomplish this in one of two ways.

The fluid may first be sprayed on to the inlet annulus 101 on each of the first end plate 45 and the second end plate 46 of the rotor 40 using the fluid jet 23, as in a third step 603, and a fourth step 604. The fluid is gathered in the inlet annulus 101 in the first end plate 45 and the second end plate 46, with the inlet annulus 101 connected to a plurality of passages 100 disposed within the first end plate 45, the plurality of center plates 70, and the second end plate 46. In a fifth step 605, fluid pressure builds within the inlet annulus 101 and travels through the plurality of passages 100. In a sixth step 606, the fluid flows to the outlet annulus 102 disposed in each of the first end plate 45 and the second end plate 46 from the plurality of passages 100. The fluid gathers in the outlet annulus 102 such that a dam of outlet fluid forms within the outlet annulus 102, in a seventh step 607. In an eighth step 608, fluid has built up within the outlet annulus 102 such that an excess of fluid from the dam of outlet fluid flows onto the stator 30, and eventually back to the sump 21.

Alternatively, the fluid may be flowed through the shaft 411 of the rotor 410 as illustrated with the IPM motor 400, in a ninth step 609. In a tenth step, 610 the fluid may be delivered to the rotor 410 through the bore 415 in the shaft 411 and may travel through the bore 415 and may be delivered to the forward primary annulus 431 and the reverse primary annulus 439 through the forward channel 416 and the reverse channel 417, respectively. The fluid may then be flowed into the primary fluid path 432 and the secondary annulus 433. At high rotational speed of the rotor 410, the fluid may build within the secondary annulus 433 and exit to the inlet annulus 434. In an eleventh step 611, the fluid may then build within the inlet annulus 434, pressurizing the fluid to travel through the fluid passages 436. In a twelfth step 612, the fluid may flow into the outlet annulus 437, thereby building a fluid dam within the outlet annulus 437 in a thirteenth step 613, and out of the fluid outlet 438 onto the stator 420 in a fourteenth step 614.

In yet another alternate embodiment, the rotor 510 of the IPM motor 500 may be connected to an output gearing of another piece of machinery that may require additional fluid to lubricate and/or cool the output gearing. In a fifteenth step 615, the rotor may deliver fluid from the bore 515 to a lubricating channel 518 and a first end 519 of the shaft 511 that is directly in contact with the output gearing.

The method 600 of operating the IPM motor 10 describes a cooling operation of the IPM motor 10 of the primary embodiment, and how in operation, the IPM motor 10 may be actively cooled such that performance losses are not experienced due to excessive heat. Greater sustained performance of the IPM motor 10 can lead to longer service life and reduced downtime. Additionally, arrangement of the plurality of passages in the snake pattern allows for greater efficiency of the cooling operation of the IPM motor 10.

The IPM motor 10 is configured to have a high degree of serviceability. Components of the rotor 40 may be configured to be fastened using removable fasteners such that the rotor 40 may be disassembled and serviced. The IPM motor may also be adapted to other machinery that is required to receive additional cooling from the IPM motor.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. An interior permanent magnet motor, comprising:
a housing including a sump and a fluid transfer system configured to transfer a fluid from the sump to other portions of the housing;
a rotor including a shaft with a first end, a second end, and a center section, further including:
a first end plate and a second end plate disposed on the center section of the shaft proximate the first end and the second end, with a center plate disposed on the center section between the first end plate and the second end plate,
a plurality of magnets disposed within a plurality of magnet slots arranged circumferentially within the center plate,
a plurality of passages formed within the first end plate, the center plate, and the second end plate extending back and forth within the rotor and configured to permit the fluid to flow from a plurality of passage inlets, through the plurality of passages within the rotor, and out of a plurality of passage outlets; and
a stator disposed within the housing about the rotor, and configured to receive electric power and induce rotation in the rotor.

2. The interior permanent magnet motor of claim 1, wherein the fluid transfer system further comprises a plurality of jets disposed within the housing and configured to spray the fluid into the plurality of passage inlets.

3. The interior permanent magnet motor of claim 2, wherein the first end plate and the second end plate further comprise:
an inlet annulus disposed on an outer surface and connected to the plurality of passage inlets, the inlet annulus configured to receive the spray from the plurality of jets and gather the fluid such that a fluid pressure builds within the inlet annulus and travels through the plurality of passages; and
an outlet annulus disposed on the outer surface and connected to the plurality of passage outlets, the outlet annulus configured to gather the fluid such that a dam of outlet fluid forms within the outlet annulus until an excess of fluid has built up, the excess of fluid flowing out of the rotor to the stator.

4. The interior permanent magnet motor of claim 1, wherein the shaft of the rotor further comprises:
a bore disposed in the shaft proximate a central axis of rotation extending from the second end to a bore end within the shaft; and
a plurality of channels connected to the bore and extending through a diameter of the shaft, the plurality of channels being configured to deliver the fluid to an inlet annulus disposed on an inner surface on each of the first end plate and the second end plate, the inlet annulus being connected to the plurality of passage inlets, the fluid transfer system thereby configured to deliver the fluid to the bore of the rotor, through the plurality of channels, into the inlet annulus on each of the first end plate and the second end plate, through the plurality of passages, and out of the plurality of passage outlets.

5. The interior permanent magnet motor of claim 4, wherein:
at least one of the plurality of channels is disposed proximate the inner surface of the first end plate, and is configured to deliver the fluid to a first inlet annulus in the first end plate, and through at least one of the plurality of passages in a direction from the first end plate to the second end plate; and
at least one of the plurality of channels is disposed proximate the inner surface of the second end plate, and is configured to deliver the fluid to a second inlet annulus in the second end plate, and through at least one of the plurality of passages in a direction from the second end plate to the first end plate.

6. The interior permanent magnet motor of claim 4, wherein the bore extends within the shaft from the second end through the first end and the shaft further comprises a lubricating channel proximate the first end, the lubricating channel and the bore at the first end configured such that the first end of the shaft may be connected to an output, and the fluid transfer system may deliver the fluid to the output through the shaft of the rotor.

7. The interior permanent magnet motor of claim 1, wherein the fluid is a lubricating oil.

8. A rotor configured to be used in an interior permanent magnet motor, the rotor comprising:
a shaft with a first end, a second end, and a center section;
a first end plate disposed on the center section of the shaft proximate the first end of the shaft;
a second end plate disposed on the center section of the shaft proximate the second end of the shaft;
a center plate disposed on the center section of the shaft between the first end plate and the second end plate;
a magnet disposed within a magnet slot of the center plate, the magnet configured to interact with a stator of the interior permanent magnet motor to generate a rotation of the rotor; and
a passage formed within the first end plate, the center plate, and the second end plate configured to extend back and forth within the rotor and configured to permit a fluid to flow from a passage inlet in either the first end plate or the second end plate to a passage outlet in the other of the first end plate or the second end plate, the passage being disposed in the center plate proximate the magnet.

9. The rotor of claim 8, wherein the center plate comprises a plurality of center plates forming a plurality of layers.

10. The rotor of claim 8, wherein the magnet comprises a plurality of magnets disposed within a plurality of magnet slots, the plurality of magnets being disposed evenly about an outer circumferential portion of the center plate.

11. The rotor of claim 8, wherein the first end plate and the second end plate further comprise:
an inlet annulus disposed on an outer surface and connected to the passage inlet, the inlet annulus configured to gather the fluid such that fluid pressure builds within the inlet annulus and travels through the passage to the passage outlet; and
an outlet annulus disposed on the outer surface and connected to the passage outlet, the outlet annulus configured to gather the fluid such that a dam of outlet fluid forms within the outlet annulus until an excess of fluid has built up, the excess of fluid flowing out of the rotor to the stator.

12. The rotor of claim 11, wherein the passage further comprises:
a plurality of inner passages and a plurality of outer passages disposed in the center plate, the plurality of inner passages being disposed proximate a center portion of the center plate, and the plurality of outer passages being disposed proximate an outer circumferential portion of the center plate;
a plurality of inner passage connectors disposed in the first end plate and the second end plate connecting adjacent ones of the plurality of inner passages;
a plurality of outer passage connectors disposed in the first end plate and the second end plate connecting adjacent ones of the plurality of outer passages; and
a bridge connector connecting one of the plurality of inner passages and one of the plurality of outer passages;
the passage thereby forming an uninterrupted passage from the passage inlet, through the plurality of inner passages connected by the plurality of inner passage connectors, through the bridge connector to the plurality of outer passages connected by the plurality of outer passage connectors, and out through the passage outlet.

13. The rotor of claim 12, wherein the passage further comprises a snorkel disposed in the first end plate or the second end plate, the snorkel configured to connect the passage with an orifice in the first end plate or the second end plate proximate a central portion of the first end plate or the second end plate.

14. The rotor of claim 13, wherein the passage further comprises a plurality of passages disposed evenly about the rotor, the plurality of passages oriented within the rotor such that a first one of the plurality of passages has the passage inlet and the passage outlet in the first end plate, and an adjacent one of the plurality of passages has the passage inlet and the passage outlet in the second end plate.

15. A method of operating an interior permanent magnet motor, the method comprising:
providing the interior permanent magnet motor comprising a stator and a rotor disposed within a housing, the rotor having a shaft with a first end and a second end, a first end plate, a second end plate, and a center plate;
transferring a fluid from a sump of the interior permanent magnet motor to the first end plate and the second end plate of the rotor;
gathering the fluid in an inlet annulus in the first end plate and the second end plate, the inlet annulus connected to a plurality of passages disposed within the first end plate, the center plate, and the second end plate such that fluid pressure builds within the inlet annulus and travels through the plurality of passages;
gathering the fluid in an outlet annulus disposed in the first end plate and the second end plate such that a dam of outlet fluid forms within the outlet annulus; and
flowing an excess of fluid from the dam of outlet fluid onto the stator and back into the sump.

16. The method of claim 15, wherein the fluid is an oil configured for lubricating and/or cooling the rotor, the stator, and the housing of the interior permanent magnet motor.

17. The method of claim 15, wherein transferring the fluid from the sump to the rotor further comprises:
transferring the fluid from the sump to a plurality of jets disposed circumferentially about the rotor within the housing; and
spraying the fluid from the plurality of jets into the inlet annulus, the inlet annulus being disposed on an outer surface of the first end plate and the second end plate.

18. The method of claim 15, wherein transferring the fluid from the sump to the rotor further comprises:
transferring the fluid from the sump to a bore disposed in the shaft proximate a central axis of rotation extending from the second end to a bore end within the shaft, and though a plurality of channels connected to the bore and extending through a diameter of the shaft; and
delivering the fluid to the inlet annulus, the inlet annulus being disposed on an inner surface on each of the first end plate and the second end plate.

19. The method of claim 18, further comprising the steps of:
delivering the fluid to at least one of the plurality of channels proximate the inner surface of the first end plate and to a first inlet annulus in the first end plate, and further flowing the fluid from the first inlet annulus and through at least one of the plurality of passages in a direction from the first end plate to the second end plate; and
delivering the fluid to at least one of the plurality of channels proximate the inner surface of the second end plate and to a second inlet annulus in the second end plate, and further flowing the fluid from the second inlet annulus and through at least one of the plurality of passages in a direction from the second end plate to the first end plate.

20. The method of claim 18, wherein the bore extends within the shaft from the second end through the first end and the shaft further comprises a lubricating channel proximate the first end, the method further comprising:
connecting the first end of the shaft to an output; and
delivering the fluid through the bore to the lubricating channel and the first end such that the fluid transfer system may deliver the fluid to the output through the shaft of the rotor.
